(19) United States
(12) Patent Application Publication
(10) Pub. No.: US 2026/0344923 A1
(43) Pub. Date: Nov. 5, 2026

(54) COFFEE COLD EXTRACTION CUP

(71) Applicant: Zhejiang Wuyi Wanjialong Plastic Industry Co., Ltd., Jinhua (CN)

(72) Inventor: Jianmin Wang, Jinhua (CN)

(21) Appl. No.: 19/075,938

(22) Filed: Mar. 11, 2025

(51) Int. Cl. A47J 31/32; A47J 31/00; A47J 31/52

(52) U.S. Cl. CPC A47J 31/32; A47J 31/005; A47J 31/525

(57) ABSTRACT

A coffee cold extraction cup is provided, which includes a cup body, a cold extraction chamber, a coffee powder chamber, a first air pump, and a second air pump; the cold extraction chamber and coffee powder chamber are provided in the cup body; the coffee powder chamber comminates with a lower end of the cold extraction chamber. An upper filter screen is provided between the cold extraction chamber and coffee powder chamber. The coffee powder chamber is provided with a through hole that communicates with the cup body, and a lower filter screen is provided on the through hole. The first air pump extracts gas from the cold extraction chamber, which creates negative pressure in the cold extraction chamber and promotes a rapid flow of water from the cup body into the coffee powder chamber, after sufficient contacts with the coffee powder, it enters the cold extraction chamber.

### TECHNICAL FIELD

The present disclosure relates to the field of coffee cup technologies, and in particular, to a coffee cold extraction cup.

### BACKGROUND

With the continuous development of coffee brewing technology, CN201811555536.4 discloses a coffee cold extraction device and a method for cold extraction of coffee. This technical solution involves setting up a cold extraction chamber for holding water and a coffee powder chamber for holding coffee. The bottoms of the two chambers are connected by a connector, and an air pump connected to the upper side wall of the coffee powder chamber is configured to achieve negative pressure suction and reverse pressure, allowing water to repeatedly flow and brew coffee between the two chambers, improving extraction speed and cold extraction efficiency. At the same time, each component is easy to disassemble and clean, which to some extent solves some of the problems of traditional coffee brewing technology.

However, there are still many shortcomings in the existing coffee brewing technology. The traditional method of brewing coffee with hot water decomposes the tannins in the coffee, causing a serious impact on the taste and making it difficult to present the original flavor and pure taste of the coffee. Although soaking in cold water for extraction avoids the decomposition of tannic acid, the common static extraction method has low efficiency, and after extraction, the coffee powder is mixed with the coffee liquid and needs to be filtered before drinking, making the process cumbersome.

Even the technology in CN201811555536.4 has certain limitations in practical applications. On the one hand, the structure of the device is relatively complex, and the connection and collaborative work of multiple components increase the probability of failure, making maintenance and upkeep difficult; on the other hand, it performs poorly in terms of portability, which is not conducive to the consumers using it in scenarios such as going out and traveling.

With the continuous improvement of consumers'requirements for coffee quality and drinking convenience, the existing coffee brewing equipment and methods are no longer able to meet market demand. In this application, a new coffee cold extraction cup has emerged, aimed at overcoming the shortcomings of existing technology and providing the consumers with a more efficient, convenient, and coffee quality guaranteed cold extraction experience.

### SUMMARY

The present disclosure provides a coffee cold extraction cup to address the shortcomings of existing technology.

In order to solve the above technical problems, the present disclosure is solved through the following technical solution.

A coffee cold extraction cup, including:
a cup body, configured to accommodate clean water,
a cold extraction chamber, which is provided in the cup body and configured to store ice cubes,
a coffee powder chamber, provided in the cup body and communicated to a lower end of the cold extraction chamber, an upper filter screen is provided between the cold extraction chamber and the coffee powder chamber; the coffee powder chamber is provided with a through hole that communicates with the cup body, and a lower filter screen is provided on the through hole, and the coffer powder chamber is configured to hold coffee power;
a first air pump, which is provided in the cup body and is communicated with the cold extraction chamber, and the first air pump is configured to extract gas from the cold extraction chamber; and
a second air pump, which is provided in the cup body and communicates to the cold extraction chamber; and the second air pump is configured to inflate gas into the cold extraction chamber.

In some embodiments of the present disclosure, the coffee powder chamber is detachably connected to the cold extraction chamber.

In some embodiments of the present disclosure, a first sealing ring is provided between the coffee powder chamber and the cold extraction chamber.

In some embodiments of the present disclosure, a cassette mechanism shell is provided at an upper end of the cup body, and both the first air pump and the second air pump are provided on the cassette mechanism shell; the cassette mechanism shell is detachably connected to the cold extraction chamber.

In some embodiments of the present disclosure, a second sealing ring is provided between the cassette mechanism shell and the cold extraction chamber.

In some embodiments of the present disclosure, a main pipe communicating with the cold extraction chamber is provided on the cassette mechanism shell, and a first branch pipe and a second branch pipe are respectively provided at two ends of the first air pump; the other end of the first branch pipe is connected to the main pipe, and a port at the other end of the second branch pipe is connected to an outside; one end of the second air pump is communicated with the second branch pipe, and the other end of the second air pump is communicated with the main pipe.

In some embodiments of the present disclosure, a first water level sensor extending into the cold extraction chamber is provided on the cassette mechanism shell.

In some embodiments of the present disclosure, a second water level sensor extending into the cup body is provided on the cassette mechanism shell.

In some embodiments of the present disclosure, a ventilation hole is provided on the cassette mechanism shell, and the ventilation hole is located above the second water level sensor.

In some embodiments of the present disclosure, a third sealing ring is provided between an upper end of the cassette mechanism shell and the port of the cup body, and a cup cover is fixedly provided at a top of the cassette mechanism shell, the cup cover is covered on the cup body.

Due to the adoption of the above technical solutions, the present disclosure has significant technical effects as follows.

The first air pump extracts gas from the cold extraction chamber, which can create negative pressure in the cold extraction chamber and promote a rapid flow of water from the cup body into the coffee powder chamber, after sufficient contact with the coffee powder, it enters the cold extraction chamber. The second air pump inflates the cold extraction chamber, which can increase air pressure inside the cold extraction chamber, and coffee liquid in the cold extraction chamber and coffee powder chamber is returned to the cup body. This cycle accelerates the coffee extraction process, improves the cold extraction efficiency, and significantly shortens the production time compared to traditional static cold extraction.

Providing with the upper filter screen and lower filter screen effectively prevents coffee powder from entering the cold extraction chamber and cup body, ensuring the purity of the coffee liquid, avoiding residue from affecting the taste, fully preserving the flavor and taste of the coffee, and improving the quality of the coffee.

The entire cold extraction process can be completed through the pumping and inflation operation of two air pumps, which is simple and convenient to operate without complex steps, thereby reducing the threshold for use and suitable for different groups of people.

The design of components such as the cup body, cold extraction chamber, coffee powder chamber, and air pumps is relatively independent and easy to disassemble. After use, each component can be thoroughly cleaned to maintain the cleanliness and hygiene of the utensils, thereby reducing bacterial growth, and ensuring the safety of the beverage.

### BRIEF DESCRIPTION OF DRAWINGS

FIG. 1 is a schematic structural diagram of the present disclosure.

FIG. 2 is an enlarged partial view of A.

FIG. 3 is an enlarged partial view of B.

FIG. 4 is an enlarged partial view of C.

Numeral reference: 10—cup body; 11—cold extraction chamber; 12—coffee powder chamber; 13—upper filter screen; 14—lower filter screen; 15—first air pump; 16—second air pump; 17—first sealing ring; 18—cassette mechanism shell; 19—second sealing ring; 20—main pipe; 21—first branch pipe; 22—second branch pipe; 23—first water level sensor; 24—second water level sensor; 25—third sealing ring; 26—cup cover; 121—through hole; 181—ventilation hole.

### DESCRIPTION OF EMBODIMENTS

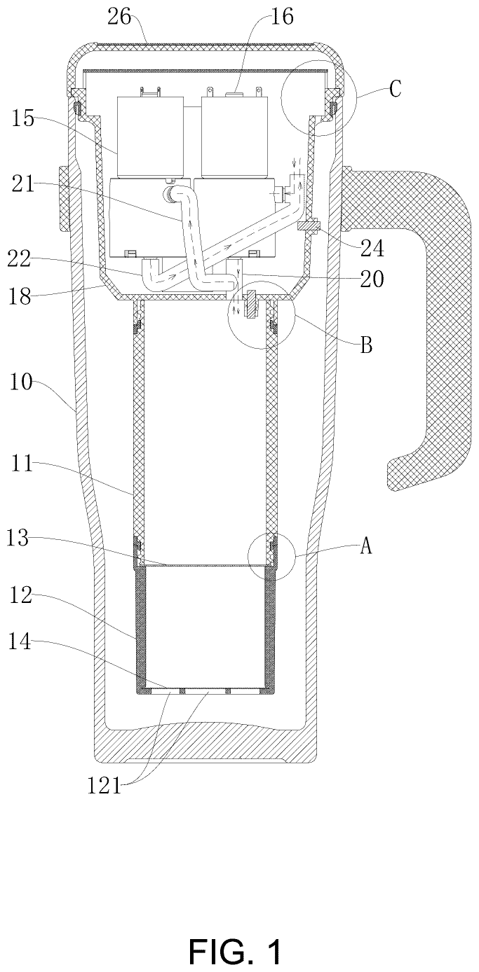

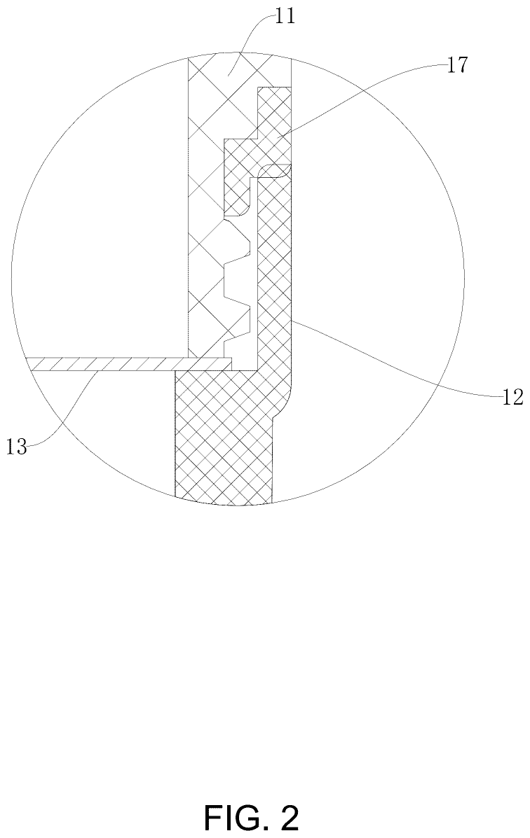

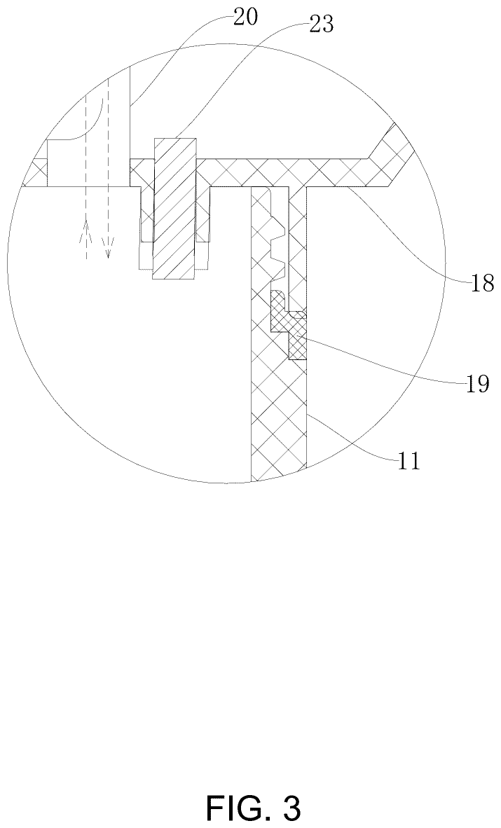

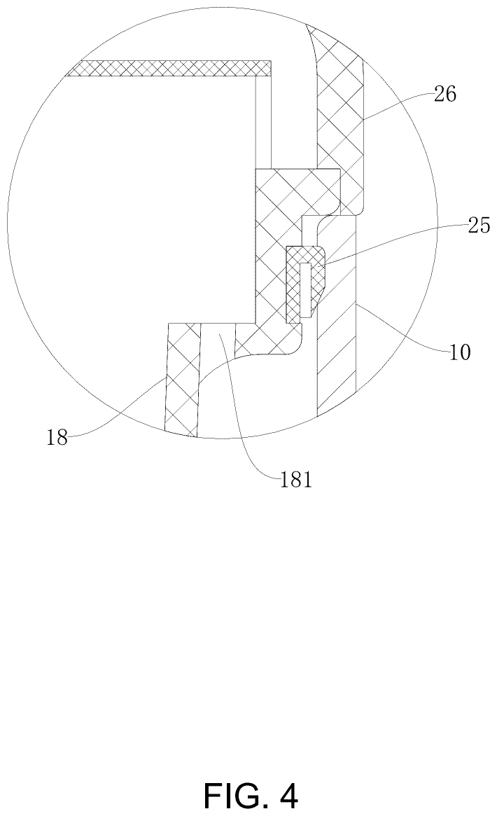

Below, a further detailed description of the present disclosure will be provided in combination with FIGS. 1-4 and the embodiments.

A coffee cold extraction cup, including:
a cup body 10, configured to accommodate clean water,
a cold extraction chamber 11, which is provided in the cup body 10 and configured to store ice cubes;
a coffee powder chamber 12, provide in the cup body 10 and communicated to a lower of the cold extraction chamber 11; an upper filter screen 13 is provided between the cold extraction chamber 11 and the coffee powder chamber 12, and the coffee powder chamber 12 is pressed onto the upper filter screen 13 to secure it to a lower end face of the cold extraction chamber 11, the upper filter screen 13 prevents coffee powder from entering the cold extraction chamber 11 and facilitates water entry into the cold extraction chamber 11; the coffee powder chamber 12 is provided with a through hole 121 that communicates to the cup body 10, and a lower filter screen 14 is provided on the through hole 121; the coffee powder chamber 12 is configured to place the coffee powder, and the lower filter screen 14 prevents the coffee powder from entering the cup body 10 and facilitates water from the cup body 10 to enter the coffee powder chamber 12;
a first air pump 15, which is an electric air pump that uses a motor as a driving source, the first air pump 15 is provided in the cup body 10 and is communicated to the cold extraction chamber 11 through a pipeline; the first air pump 15 is configured to extract gas from the cold extraction chamber 11; when the first air pump 15 is started, the water in the cup body 10 enters the cold extraction chamber 11 through the coffee powder chamber 12 and rises to a set position; and
a second air pump 16, which is an electric air pump that uses a motor as a driving source, the second air pump 16 is provided in the cup body 10 and is communicated to the cold extraction chamber 11 through a pipeline; the second air pump 16 is configured to inflate gas into the cold extraction chamber 11; when the second air pump 16 is started, the first air pump 15 is stopped, and the air pressure inside the cold extraction chamber 11 is increased; coffee liquid in the cold extraction chamber 11 and the coffee powder chamber 12 is returned to the cup body 10.

When the coffee cold extraction cup is working, the first air pump 15 and the second air pump 16 are alternately started. The cup body 10 accommodates clean water, cold extraction chamber 11 stores ice cubes, and coffee powder chamber 12 holds coffee powder. Firstly, the first air pump 15 is started to extract gas from the cold extraction chamber 11, so that the water in the cup body 10 enters the coffee powder chamber 12 through the through hole 121 on the coffee powder chamber 12 and the lower filter screen 14 under a pressure difference, and then enters the cold extraction chamber 11 through the upper filter screen 13 and rises to the set position. At this point, the first air pump 15 is stopped and the second air pump 16 is started, the cold extraction chamber 11 is filled with gas, and the coffee liquid in the cold extraction chamber and the coffee powder chamber is returned to the cup body. This cycle completes the cold extraction process.

By setting the first air pump 15 and the second air pump 16 to work alternately, the flow of water between the cold extraction chamber 11 and the coffee powder chamber 12 can be effectively controlled, thereby achieving automation of the coffee cold extraction process without the need for manual water pouring and other operations, which it more convenient. At the same time, providing the upper filter screen 13 and lower filter screen 14 prevents coffee powder from entering other containers during the cold extraction process, ensuring the purity of the coffee liquid; on the other hand, it can also facilitate a smooth flow of water and ensure smooth progress of the cold extraction process. Besides that, the clever arrangement of various components, such as the connection and installation of the cold extraction chamber 11 and coffee powder chamber 12 inside the cup body 10, renders the entire coffee cold extraction cup structure compact and reasonable, easy to carry and use.

The coffee powder chamber 12 is detachably connected to the cold extraction chamber 11, and the coffee powder chamber 12 is threaded connected to the cold extraction chamber 11. The coffee powder chamber 12 is easy to disassemble and assemble, rendering it convenient for a user to clean the coffee powder chamber 12 and place the coffee powder.

A first sealing ring 17 is provided between the coffee powder chamber 12 and the cold extraction chamber 11. The first sealing ring 17 between the cold extraction chamber 11 and the coffee powder chamber 12 greatly enhances the sealing performance, thereby preventing water and gas leakage during cold extraction, and avoiding affecting the cold extraction effect and causing usage problems.

An upper end of the cup body 10 is provided with a cassette mechanism shell 18, and both the first air pump 15 and the second air pump 16 are provided on the cassette mechanism shell 18. The cassette mechanism shell 18 is detachably connected to the cold extraction chamber 11, and the cold extraction chamber 11 is threaded connected to the cassette mechanism shell 18. The cassette mechanism shell 18 is configured to install the first air pump 15 and the second air pump 16, and is further configured to isolate water. The first air pump 15 and the second air pump 16 are provided in the cassette mechanism shell 18 at the upper end of the cup body 10, with a more reasonable layout, thereby effectively utilizing space, avoiding direct contact between the air pump and water, and extending the service life of the air pump. The cassette mechanism shell 18 and the cold extraction chamber 11 are connected by detachable threads, rendering it convenient for the user to disassemble and clean various components after use, maintaining the cleanliness and hygiene of the equipment, and improving the user experience. The cassette mechanism shell 18 not only provides stable installation space for the first air pump 15 and the second air pump 16, but also serves to isolate water, preventing damage to the air pump and related circuits, and ensuring the stable operation of the coffee cold extraction cup.

A second sealing ring 19 is provided between the cassette mechanism shell 18 and the cold extraction chamber 11. The second sealing ring 19 can effectively prevent water from the cold extraction chamber 11 from directly entering the cup body 10 without going through the cold extraction process, and also prevent water from the cup body 10 from directly flowing into the cold extraction chamber 11.

A main pipe 20 communicating to the cold extraction chamber 11 is provided on the cassette mechanism shell 18. The first air pump 15 is provided with a first branch pipe 21 and a second branch pipe 22 at two ends. The other end of the first branch pipe 21 is connected to the main pipe 20, and the first branch pipe 21 is integrally formed with the main pipe 20. A port at the other end of the second branch pipe 22 is communicated to an outside world. One end of the second air pump 16 is communicated to the second branch pipe 22, and the other end of the second air pump 16 is communicated to the main pipe 20. The first air pump 15 and the second air pump 16 share the main pipe 20 and the second branch pipe 22, thereby reducing the number of components, lowering production costs, and simplifying the air circuit structure, making daily maintenance and troubleshooting more convenient. In terms of performance collaboration, two air pumps share these components, which enables more efficient gas exchange and pressure regulation. When the first air pump 15 extracts gas from the cold extraction chamber 11, the gas is discharged through the second branch pipe 22 to maintain a normal operation of the air pump; when the second air pump 16 is working, it can accurately inject gas into the cold extraction chamber 11 through the shared main pipe 20, thereby enhancing the continuity and accuracy of air pressure control and further improving the cold extraction efficiency. Besides that, this shared design renders the air path layout more compact and reasonable, and the entire structure of the coffee cold extraction cup is therefore more compact and lightweight. It is not only convenient to carry but also allows the user to enjoy cold brew coffee anytime and anywhere. The operation is also simpler, and it is easy for the user to get started and greatly improving the use experience. In terms of cold extraction effect, the closely related air circuit components enable the first air pump 15 and the second air pump 16 to accurately regulate the air pressure inside the cold extraction chamber 11.

A first water level sensor 23 is provided on the cassette mechanism shell 18, which is extended into the cold extraction chamber 11. The first water level sensor 23 provided on the cassette mechanism shell 18 can monitor a water level inside the cold extraction chamber 11 in real time. It can provide accurate water level data for the entire cold extraction process, helping the equipment achieve more intelligent automation control. When the water level reaches the preset upper or lower limit, the sensor will promptly provide feedback signals and automatically control the start and stop of the first air pump 15 and the second air pump 16 to avoid cold extraction failure or equipment damage caused by abnormal water level.

A third sealing ring 25 is provided between an upper end of the cassette mechanism shell 18 and the port of the cup body 10. A top of the cassette mechanism shell 18 is fixedly provided with a cup cover 26, and the cup cover 26 is covered on the cup body 10. The third sealing ring 25, together with the cup cover 26 fixed at the top, greatly enhances the sealing of the cup. The cup cover 26 is covered on the cup body 10, which can effectively prevent liquid overflow and avoid coffee or water spillage caused by shaking during carrying. It not only ensures the convenience of use but also prevents liquid leakage from causing damage to the equipment. The third sealing ring 25 further enhances the sealing effect, isolating external air and dust from entering the cup body, ensuring that the coffee is not disturbed by external factors during the cold extraction process, and maintaining the freshness and purity of the coffee. At the same time, good sealing also renders the cold brew cup safer and more reliable to carry, whether placed in a backpack or held in hand, there is no need to worry about liquid leakage, allowing the user to enjoy the process of coffee cold extraction cup anytime and anywhere with peace of mind.

In an implementation mode, a second water level sensor 24 is provided on the cassette mechanism shell 18, which is extended into the cup body 10. The second water level sensor 24 can monitor the water level inside the cup body 10 in real time. On the one hand, it provides the user with accurate water quantity information, rendering it easier for him to adjust the ratio of coffee powder to water according to his actual needs, thereby customizing cold brew coffee that is more in line with his personal taste. On the other hand, during the cold extraction process, a working state of the air pump can be adjusted in a timely manner according to changes in the water level of the cup, ensuring the stability and smoothness of the cold extraction process.

In an implementation mode, the cassette mechanism shell 18 is provided with a ventilation hole 181, and the ventilation hole 181 is located above the second water level sensor 24. The second water level sensor 24 can monitor the water level inside the cup body 10 in real time. On the one hand, it provides the user with accurate water quantity information, rendering it easier for him to adjust the ratio of coffee powder to water according to his actual needs, thereby customizing cold brew coffee that is more in line with his personal taste.

What is claimed is:

1. A coffee cold extraction cup, comprising:
a cup body,
a cold extraction chamber, which is provided in the cup body;
a coffee powder chamber, provided in the cup body and communicated to a lower end of the cold extraction chamber, an upper filter screen is provided between the cold extraction chamber and the coffee powder chamber; the coffee powder chamber is provided with a through hole that communicates with the cup body, and a lower filter screen is provided on the through hole;
a first air pump, which is provided in the cup body and is communicated with the cold extraction chamber, and the first air pump is configured to extract gas from the cold extraction chamber; and
a second air pump, which is provided in the cup body and communicates to the cold extraction chamber; and the second air pump is configured to inflate gas into the cold extraction chamber.

2. The coffee cold extraction cup according to claim 1, wherein the coffee powder chamber is detachably connected to the cold extraction chamber.

3. The coffee cold extraction cup according to claim 1, wherein a first sealing ring is provided between the coffee powder chamber and the cold extraction chamber.

4. The coffee cold extraction cup according to claim 1, wherein a cassette mechanism shell is provided at an upper end of the cup body, and both the first air pump and the second air pump are provided on the cassette mechanism shell;
the cassette mechanism shell is detachably connected to the cold extraction chamber.

5. The coffee cold extraction cup according to claim 4, wherein a second sealing ring is provided between the cassette mechanism shell and the cold extraction chamber.

6. The coffee cold extraction cup according to claim 4, wherein a main pipe communicating with the cold extraction chamber is provided on the cassette mechanism shell, and a first branch pipe and a second branch pipe are respectively provided at two ends of the first air pump;
the other end of the first branch pipe is connected to the main pipe, and a port at the other end of the second branch pipe is communicated to an outside;
one end of the second air pump is communicated with the second branch pipe, and the other end of the second air pump is communicated with the main pipe.

7. The coffee cold extraction cup according to claim 4, wherein a first water level sensor extending into the cold extraction chamber is provided on the cassette mechanism shell.

8. The coffee cold extraction cup according to claim 4, wherein a second water level sensor extending into the cup body is provided on the cassette mechanism shell.

9. The coffee cold extraction cup according to claim 8, wherein a ventilation hole is provided on the cassette mechanism shell, and the ventilation hole is located above the second water level sensor.

10. The coffee cold extraction cup according to claim 4, wherein a third sealing ring is provided between an upper end of the cassette mechanism shell and the port of the cup body, and a cup cover is fixedly provided at a top of the cassette mechanism shell, the cup cover is covered on the cup body.
